(19) United States
(12) Patent Application Publication
(10) Pub. No.: US 2025/0379832 A1
(43) Pub. Date: Dec. 11, 2025

(54) DATA TRANSMISSION METHOD, ETHERNET DEVICE, AND OPTICAL PASSIVE SWITCHING SYSTEM

(71) Applicant: Ruijie Networks Co., Ltd., Fuzhou (Fujian) (CN)

(72) Inventors: Wurong PAN, Fuzhou (CN); Longshun WANG, Fuzhou (CN)

(21) Appl. No.: 19/308,629

(22) Filed: Aug. 25, 2025

Related U.S. Application Data
(63) Continuation of application No. PCT/CN2024/079101, filed on Feb. 28, 2024.

(30) Foreign Application Priority Data
Feb. 28, 2023 (CN) 202310176217.7

(51) Int. Cl. H04L 49/351; H04B 10/61

(52) U.S. Cl. CPC H04L 49/351; H04B 10/614

(57) ABSTRACT

The present application discloses an Ethernet device and a data transmission method. A core Ethernet device includes a first Ethernet MAC chip and a first optical module. The first optical module is configured to receive an uplink packet sent by an optical splitter. The uplink packet is sent by a first access Ethernet device to the optical splitter within a first sending period. The first sending period does not overlap with one or more second sending periods corresponding to one or more second access Ethernet devices connected to the optical splitter. The first Ethernet MAC chip is configured to transmit a downlink packet to the first optical module. The first optical module is further configured to send the downlink packet to the optical splitter, so that the optical splitter sends the downlink packet to the first access Ethernet device and the one or more second access Ethernet devices.

### CROSS-REFERENCE TO RELATED APPLICATIONS

This application is a continuation of International Application No. PCT/CN2024/079101, filed on Feb. 28, 2024, which claims priority to Chinese Patent Application No. 202310176217.7, filed with the China National Intellectual Property Administration on Feb. 28, 2023 and entitled “DATA TRANSMISSION METHOD, ETHERNET DEVICE, AND PASSIVE OPTICAL EXCHANGE SYSTEM,” both of which are incorporated herein by reference in their entireties.

### TECHNICAL FIELD

The present application relates to the field of communication technology, and more particularly, to a data transmission method, an Ethernet device, and a computer-readable storage medium.

### BACKGROUND

In the IEEE 802.3 protocol standard, the medium access control (MAC) layer and the physical layer (PHY) of Ethernet are defined. The medium access control layer employs carrier sense multiple access with collision detection (CSMA/CD). All stations adopting this mechanism share the transmission medium and need to monitor the transmission medium, randomly delaying the sending of packets after detecting that other stations are sending packets.

In related technologies, devices are interconnected through switches, enabling full-duplex data exchange between each station with exclusive transmission bandwidth. In other words, switches are required to support data exchange and transmission between the central office and the terminal.

However, as the network scale grows larger, the deployment of active switches in Ethernet becomes increasingly complex, and the management of switches becomes more challenging.

### SUMMARY

An embodiment of the present application provides a data transmission method, an Ethernet device, and a passive optical exchange system, capable of achieving data exchange and transmission through passive components.

According to a first aspect, an embodiment of the present application provides a core Ethernet device, including a first Ethernet medium access control chip and a first optical module connected to the first Ethernet MAC chip, where:
the first optical module is configured to receive an uplink packet sent by an optical splitter; the uplink packet is sent by an access Ethernet device to the optical splitter within a corresponding sending period, and the sending periods corresponding to access Ethernet devices connected to the optical splitter do not overlap;
the first Ethernet MAC chip is configured to transmit a downlink packet to the first optical module; and
the first optical module is further configured to send the downlink packet to the optical splitter, so that the optical splitter sends the downlink packet to each connected access Ethernet device.

The above scheme does not require a passive optical network (PON) chip. Instead, packets in Ethernet frame format utilize the MAC chip of network devices in traditional network architectures to achieve passive optical transmission between Ethernet network devices, with the optical splitter enabling passive optical splitting. Additionally, downlink packets are transmitted via broadcasting, eliminating the need to process packets in Ethernet frame format into PON frame format. Instead, uplink packet transmission is managed by ensuring that the sending periods of access devices do not overlap. In other words, different access Ethernet devices transmit uplink packets within distinct sending periods, and each access Ethernet device sends uplink packets only within its corresponding sending period. This eliminates the need to deploy active switches between customer premises equipment and central office devices for data exchange and transmission. The optical splitter performs passive optical splitting, avoiding uplink packet collisions during passive optical splitting. This embodiment does not require additional external chips or CPUs for packet processing (the packet processing may include packet integration, packet splitting, or format conversion, for example, changing the frame format of packets from Ethernet frame format to PON format), enabling passive optical splitting.

In some optional embodiments, the uplink packet and the downlink packet are packets in standard Ethernet frame format.

In some optional embodiments, the first Ethernet MAC chip is further configured to:
determine historical transmission traffic of each access Ethernet device;
based on the historical transmission traffic of all access Ethernet devices, determine a sending start time point and a sending duration for each access Ethernet device; and
transmit a first downlink packet carrying an address of an access Ethernet device, the corresponding sending start time point, and the sending duration to the first optical module.

The above scheme reflects the sending requirements of each access Ethernet device through the historical transmission traffic, such as how often data transmission is needed and how long each data transmission takes. Based on the historical transmission traffic of all access Ethernet devices, the sending start time point and sending duration (that is, the corresponding sending period) for each access Ethernet device can be reasonably determined. Subsequently, the first downlink packet carrying the address of the access Ethernet device, the corresponding sending start time point, and the sending duration is transmitted to the first optical module, enabling the corresponding access Ethernet device to obtain its sending period.

In some optional embodiments, the first Ethernet MAC chip is further configured to:
at preset intervals, transmit a second downlink packet carrying the address of an access Ethernet device and a first sending time to the first optical module, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determine a target adjustment time for the corresponding access Ethernet device; where the second receiving time is a time when the core Ethernet device receives the target uplink packet; and
transmit a third downlink packet carrying the address of the access Ethernet device and the corresponding target adjustment time to the first optical module, so that the corresponding access Ethernet device, upon receiving the third downlink packet, adjusts a clock module from a current time to the corresponding target adjustment time.

In some optional embodiments, the first Ethernet MAC chip is specifically configured to:
subtract the first sending time from the second receiving time to determine a response interval;
subtract the first receiving time from the second sending time to determine a processing duration of the access Ethernet device;
subtract the processing duration from the response interval to obtain an uplink and downlink round-trip time, where half of the round-trip time is a single transmission duration;
add the single transmission duration to the first sending time to obtain a theoretical receiving time;
compare the first receiving time with the theoretical receiving time to obtain a time error; and
determine a sum of the current time, the time error, and the single transmission duration as the target adjustment time.

In the above exemplary schemes, through periodic interactions involving packets carrying time information between the core Ethernet device and each access Ethernet device at preset intervals, time correction for each access Ethernet device is achieved, ensuring a unified time standard among access Ethernet devices and further reducing the occurrence of uplink packet collisions.

According to a second aspect, an embodiment of the present application provides an access Ethernet device, including a second Ethernet MAC chip and a second optical module connected to the second Ethernet MAC chip, where:
the second Ethernet MAC chip is configured to place an uplink packet into a packet queue; and within a sending period corresponding to the access Ethernet device, sequentially retrieve uplink packets from the packet queue and transmit the uplink packets to the second optical module;
the second optical module is configured to send the uplink packets to an optical splitter, so that the optical splitter sends the uplink packets to a core Ethernet device; and
the second optical module is further configured to determine whether a destination address of a downlink packet sent by the optical splitter is an address corresponding to the access Ethernet device; and if so, receive the downlink packet; otherwise, discard the downlink packet; where the downlink packet is sent by the optical splitter to each connected access Ethernet device after receiving the downlink packet sent from the core Ethernet device; where
the sending periods corresponding to the access Ethernet switching devices connected to the optical splitter do not overlap.

The above scheme achieves passive optical transmission between Ethernet network devices, with the optical splitter enabling passive optical splitting. Downlink packets are transmitted via broadcasting, and uplink packets are transmitted within distinct sending periods corresponding to different access Ethernet devices. Each access Ethernet device sends uplink packets only within its corresponding sending period, eliminating the need to deploy active switches between customer premises equipment and central office devices for data exchange and transmission. The optical splitter performs passive optical splitting, avoiding uplink packet collisions during passive optical splitting. This embodiment does not require additional external chips, enabling passive optical splitting. In the exemplary embodiments of the present application, the transmitted packets are all in standard Ethernet frame format, without modifying the format of Ethernet packets. Instead, high-precision time synchronization is achieved using the Ethernet time synchronization protocol, and the core Ethernet device synchronizes non-overlapping sending periods to each access Ethernet device. Each access Ethernet device sends uplink packets based on its assigned sending period. By modifying the CSMA/CD mechanism of the MAC layer for sending uplink packets to a TDMA mechanism, time-division sending for each access Ethernet device is achieved, thereby enabling optical transmission.

In some optional embodiments, the uplink packet and the downlink packet are packets in standard Ethernet frame format.

In some optional embodiments, the second Ethernet MAC chip is specifically configured to:
if a current time point is within the sending period of the access Ethernet device, sequentially retrieve uplink packets from the packet queue according to an order in which the uplink packets are stored in the packet queue.

The above scheme caches uplink packets in a packet queue. If the current time point is within the corresponding sending period, uplink packets are retrieved from the packet queue in the order they were stored and sent to the optical splitter, reducing uplink packet collisions and enabling orderly transmission of uplink packets.

In some optional embodiments, before sequentially retrieving uplink packets from the packet queue, the second Ethernet MAC chip is further configured to:
activate a light source of the second optical module and a switch indicative of sending in the second Ethernet MAC chip; and
after the second optical module sends the uplink packet to the optical splitter, the second Ethernet MAC chip is further configured to:
if there are no uplink packets in the packet queue or the sending period of the access Ethernet device ends, deactivate the switch indicative of sending in the second Ethernet MAC chip and the light source of the second optical module.

The above scheme activates the light source of the second optical module when the access Ethernet device needs to send data, followed by activating the switch indicative of sending in the second Ethernet MAC chip. After the access Ethernet device determines that no further data needs to be sent (that is, there are no uplink packets in the packet queue or the corresponding sending period has ended), the switch indicative of sending in the second Ethernet MAC chip is deactivated, followed by deactivating the light source of the second optical module. This ensures that, during the entire sending process, the switch indicative of sending in the second Ethernet MAC chip remains activated and the light source of the second optical module remains on, enabling the transmission of uplink packets. Outside the sending process, the switch indicative of sending in the second Ethernet MAC chip remains deactivated, and the light source of the second optical module remains off, reducing the transmission of empty packets from the access Ethernet device and minimizing optical interference with other access Ethernet devices.

In some optional embodiments, the switch indicative of sending is a circuit switch provided on a transmission circuit; where the transmission circuit includes a transmission circuit of a MAC layer and a transmission circuit of a physical layer of the access Ethernet device.

According to a third aspect, an embodiment of the present application provides a passive optical exchange system, including a core Ethernet device, at least one optical splitter, and an access Ethernet device, where
the access Ethernet device is configured to send an uplink packet to a corresponding optical splitter within a corresponding sending period; where the sending period is allocated by the core Ethernet device for each access Ethernet device connected to the optical splitter, and the sending periods corresponding to access Ethernet devices connected to the optical splitter do not overlap;
the optical splitter is configured to send the uplink packet to the core Ethernet device;
the core Ethernet device is further configured to send a downlink packet to a corresponding optical splitter;
the optical splitter is further configured to send the downlink packet to each connected access Ethernet device; and
the access Ethernet device is further configured to determine whether a destination address of the downlink packet sent by the optical splitter is an address corresponding to the access Ethernet device and if so, receive the downlink packet;
otherwise, discard the downlink packet.

In some optional embodiments, if there are a plurality of optical splitters, different optical splitters are connected to different optical modules in the core Ethernet device.

In some optional embodiments, the core Ethernet device is further configured to:
determine historical transmission traffic of each access Ethernet device;
based on the historical transmission traffic of all access Ethernet devices, determine a sending start time point and a sending duration for each access Ethernet device; and
send a first downlink packet carrying an address of the access Ethernet device, the corresponding sending start time point, and the sending duration to the optical splitter.

In some optional embodiments, the core Ethernet device is further configured to: at preset intervals, send a second downlink packet carrying the address of the access Ethernet device and a first sending time to the optical splitter; where the first sending time is a sending time of the second downlink packet;
the access Ethernet device is further configured to, upon receiving the second downlink packet, send a target uplink packet carrying a first receiving time and a second sending time to the optical splitter; where the first receiving time is a time when the corresponding access Ethernet device receives the second downlink packet, and the second sending time is a time when the corresponding access Ethernet device sends the target uplink packet;
the core Ethernet device is further configured to, based on a second receiving time, the first sending time, the first receiving time, and the second sending time, determine a target adjustment time for the corresponding access Ethernet device; where the second receiving time is a time when the core Ethernet device receives the target uplink packet;
the core Ethernet device is further configured to send a third downlink packet carrying the address of the access Ethernet device and the corresponding target adjustment time to the optical splitter; and
the access Ethernet device is further configured to, upon receiving the third downlink packet, adjust a clock module from a current time to the corresponding target adjustment time.

In some optional embodiments, the access Ethernet device is specifically configured to:
if a current time point is within the sending period of the access Ethernet device, sequentially retrieve uplink packets from the packet queue according to an order in which the uplink packets are stored in the packet queue and send the retrieved uplink packets to the optical splitter.

In some optional embodiments, the access Ethernet device is further configured to:
before the sending the uplink packet from the packet queue to an optical splitter within a sending period corresponding to the access Ethernet device, activate a light source of a second optical module of the access Ethernet device and a switch indicative of sending in a second Ethernet MAC chip of the access Ethernet device; and
after the sending the uplink packet from the packet queue to an optical splitter within a sending period corresponding to the access Ethernet device, if there are no uplink packets in the packet queue or the sending period of the access Ethernet device ends, deactivate the switch indicative of sending in the second Ethernet MAC chip and the light source of the second optical module.

According to a fourth aspect, an embodiment of the present application provides a first data transmission method applied to a controller of a core Ethernet device, the method including:
receiving an uplink packet sent by an optical splitter; where the uplink packet is sent by an access Ethernet device to the optical splitter within a corresponding sending period, and the sending periods corresponding to Ethernet devices connected to the optical splitter do not overlap; and
sending a downlink packet to the optical splitter, so that the optical splitter sends the downlink packet to each connected access Ethernet device.

In some optional embodiments, the method further includes:
determining historical transmission traffic of each access Ethernet device;
based on the historical transmission traffic of all access Ethernet devices, determining a sending start time point and a sending duration for each access Ethernet device; and
sending a first downlink packet carrying an address of the access Ethernet device, the corresponding sending start time point, and the sending duration to the optical splitter.

In some optional embodiments, the method further includes:
at preset intervals, sending a second downlink packet carrying an address of the access Ethernet device and a first sending time to the optical splitter, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determining a target adjustment time for the corresponding access Ethernet device; where the second receiving time is a time when the core Ethernet device receives the target uplink packet; and
sending a third downlink packet carrying the address of the access Ethernet device and the corresponding target adjustment time to the optical splitter, so that the corresponding access Ethernet device, upon receiving the third downlink packet, adjusts a clock module from a current time to the corresponding target adjustment time.

In some optional embodiments, the uplink packet and the downlink packet are packets in standard Ethernet frame format.

In some optional embodiments, the based on a second receiving time, the first sending time, the first receiving time, and the second sending time, determining a target adjustment time for the corresponding access Ethernet device specifically includes:
subtracting the first sending time from the second receiving time to determine a response interval;
subtracting the first receiving time from the second sending time to determine a processing duration of the access Ethernet device;
subtracting the processing duration from the response interval to obtain an uplink and downlink round-trip time, where half of the round-trip time is a single transmission duration;
adding the single transmission duration to the first sending time to obtain a theoretical receiving time;
comparing the first receiving time with the theoretical receiving time to obtain a time error; and
determining a sum of the current time, the time error, and the single transmission duration as the target adjustment time.

According to a fifth aspect, an embodiment of the present application provides a data transmission method applied to a controller of an access Ethernet device, the method including:
placing an uplink packet into a packet queue in the access Ethernet device and sending the uplink packet from the packet queue to an optical splitter within a sending period corresponding to the access Ethernet device, so that the optical splitter sends the uplink packets to a core Ethernet device; and
determining whether a destination address of a downlink packet sent by the optical splitter is an address corresponding to the access Ethernet device; and if so, receiving the downlink packet; otherwise, discarding the downlink packet; where the downlink packet is sent by the optical splitter to each connected access Ethernet device after receiving the downlink packet from the core Ethernet device; where
the sending periods corresponding to access Ethernet switching devices connected to the optical splitter do not overlap.

In some optional embodiments, the sending the uplink packet from the packet queue to an optical splitter within a sending period corresponding to the access Ethernet device includes:
if a current time point is within the sending period of the access Ethernet device, sequentially retrieving uplink packets from the packet queue according to an order in which the uplink packets are stored in the packet queue and sending the retrieved uplink packets to the optical splitter.

In some optional embodiments, before the sending the uplink packet from the packet queue to an optical splitter within the sending period corresponding to the access Ethernet device, the method further includes:
activating a light source of a second optical module of the access Ethernet device and a switch indicative of sending in a second Ethernet MAC chip of the access Ethernet device; and
after the sending the uplink packet from the packet queue to an optical splitter within a sending period corresponding to the access Ethernet device, the method further includes:
if there are no uplink packets in the packet queue or the sending period of the access Ethernet device ends, deactivating the switch indicative of sending in the second Ethernet MAC chip and the light source of the second optical module.

According to a sixth aspect, an embodiment of the present application provides a first data transmission apparatus applied to a controller of a core Ethernet device, the apparatus including:
an uplink packet receiving module configured to receive an uplink packet sent by an optical splitter; the uplink packet is sent by an access Ethernet device to the optical splitter within a corresponding sending period, and the sending periods corresponding to access Ethernet devices connected to the optical splitter do not overlap; and
a downlink packet sending module configured to send a downlink packet to the optical splitter, so that the optical splitter sends the downlink packet to each connected access Ethernet device.

According to a seventh aspect, an embodiment of the present application provides a data transmission apparatus applied to a controller of an access Ethernet device, the apparatus including:
an uplink packet sending module configured to place an uplink packet into a packet queue in the access Ethernet device and send the uplink packet from the packet queue to an optical splitter within a sending period corresponding to the access Ethernet device, so that the optical splitter sends the uplink packets to a core Ethernet device;
a downlink packet receiving module configured to determine whether a destination address of a downlink packet sent by the optical splitter is an address corresponding to the access Ethernet device; and if so, receive the downlink packet; otherwise, discard the downlink packet; where the downlink packet is sent by the optical splitter to each connected access Ethernet device after receiving the downlink packet sent from the core Ethernet device; where
the sending periods corresponding to access Ethernet switching devices connected to the optical splitter do not overlap.

According to an eighth aspect, an embodiment of the present application provides a computer-readable storage medium storing a computer program executable by a processor, where, when the program runs on the processor, the processor executes the data transmission method according to any one of the fourth aspect or the fifth aspect.

According to a ninth aspect, an embodiment of the present application provides a core Ethernet device, including a first Ethernet medium access control MAC chip and a first optical module connected to the first Ethernet MAC chip, where:
the first optical module is configured to receive an uplink packet sent by an optical splitter; the uplink packet is sent by a first access Ethernet device to the optical splitter within a first sending period, and the first sending period does not overlap with one or more second sending periods corresponding to one or more second access Ethernet devices connected to the optical splitter;
the first Ethernet MAC chip is configured to transmit a downlink packet to the first optical module; and
the first optical module is further configured to send the downlink packet to the optical splitter, so that the optical splitter sends the downlink packet to the first access Ethernet device and the one or more second access Ethernet devices.

In some optional embodiments, the uplink packet and the downlink packet are packets in standard Ethernet frame format.

In some optional embodiments, the first Ethernet MAC chip is further configured to:
determine historical transmission traffic of the first access Ethernet device;
based on the historical transmission traffic of the first access Ethernet device, determine a sending start time point and a sending duration for the first access Ethernet device;
transmit a first downlink packet carrying an address of the first access Ethernet device, the sending start time point, and the sending duration to the first optical module.

In some optional embodiments, the first Ethernet MAC chip is further configured to:
at preset intervals, transmit a second downlink packet carrying an address of the first access Ethernet device and a first sending time to the first optical module, so that the first access Ethernet device, upon receiving the second downlink packet, sends a target uplink packet carrying a first receiving time and a second sending time to the optical splitter; where the first sending time is a sending time of the second downlink packet, the first receiving time is a time when the first access Ethernet device receives the second downlink packet, and the second sending time is a time when the first access Ethernet device sends the target uplink packet;
based on a second receiving time, the first sending time, the first receiving time, and the second sending time, determine a target adjustment time for the first access Ethernet device; where the second receiving time is a time when the core Ethernet device receives the target uplink packet; and
transmit a third downlink packet carrying the address of the first access Ethernet device and the target adjustment time to the first optical module, so that the first access Ethernet device, upon receiving the third downlink packet, adjusts a time of the first access Ethernet device from a current time to the target adjustment time.

In some optional embodiments, the first Ethernet MAC chip is configured to, based on the second receiving time, the first sending time, the first receiving time, and the second sending time, determine the target adjustment time for the first access Ethernet device, including:
subtracting the first sending time from the second receiving time to determine a response interval;
subtracting the first receiving time from the second sending time to determine a processing duration of the first access Ethernet device;
subtracting the processing duration from the response interval to obtain an uplink and downlink round-trip time, where half of the round-trip time is a single transmission duration;
adding the single transmission duration to the first sending time to obtain a theoretical receiving time;
comparing the first receiving time with the theoretical receiving time to obtain a time error; and
determining a sum of the current time, the time error, and the single transmission duration as the target adjustment time.

According to a tenth aspect, an embodiment of the present application provides an access Ethernet device, including a second Ethernet medium access control MAC chip and a second optical module connected to the second Ethernet MAC chip, where:

the second Ethernet MAC chip is configured to place an uplink packet into a packet queue; and within a first sending period corresponding to the access Ethernet device, sequentially retrieve uplink packets from the packet queue and transmit the uplink packets to the second optical module;

the second optical module is configured to send the uplink packets to an optical splitter, so that the optical splitter sends the uplink packets to a core Ethernet device; and
the second optical module is further configured to determine whether a destination address of a downlink packet sent by the optical splitter is an address corresponding to the access Ethernet device; and if so, receive the downlink packet; otherwise, discard the downlink packet; where the downlink packet is sent by the optical splitter to the access Ethernet device and one or more second access Ethernet devices connected to the optical splitter after receiving the downlink packet sent from the core Ethernet device; where
the first sending period does not overlap with one or more second sending periods corresponding to the one or more second access Ethernet switching devices.

In some optional embodiments, the uplink packet and the downlink packet are packets in standard Ethernet frame format.

In some optional embodiments, the second Ethernet MAC chip is specifically configured to:
if a current time point is within the first sending period of the access Ethernet device, sequentially retrieve uplink packets from the packet queue according to an order in which the uplink packets are stored in the packet queue.

In some optional embodiments, before sequentially retrieving uplink packets from the packet queue, the second Ethernet MAC chip is further configured to:
activate a light source of the second optical module and a switch indicative of sending in the second Ethernet MAC chip; and
after the second optical module sends the uplink packet to the optical splitter, the second Ethernet MAC chip is further configured to:
if there are no uplink packets in the packet queue or the first sending period of the access Ethernet device ends, deactivate the switch indicative of sending in the second Ethernet MAC chip and the light source of the second optical module.

In some optional embodiments, the switch indicative of sending is a switch provided on a transmission circuit; where the transmission circuit includes a transmission circuit of a MAC layer and a transmission circuit of a physical layer of the access Ethernet device.

According to an eleventh aspect, an embodiment of the present application provides a passive optical exchange system, including a core Ethernet device, an optical splitter, and a plurality of access Ethernet devices, the plurality of access Ethernet devices including a first access Ethernet device connected to the optical splitter and one or more second access Ethernet devices connected to the optical splitter, where:
the first access Ethernet device is configured to send an uplink packet to the optical splitter within a corresponding first sending period; where the first sending period is allocated by the core Ethernet device for the first access Ethernet device connected to the optical splitter, and the first sending period does not overlap with one or more second sending periods corresponding to the one or more second access Ethernet devices;
the optical splitter is configured to send the uplink packet to the core Ethernet device;
the core Ethernet device is further configured to send a downlink packet to a corresponding optical splitter;
the optical splitter is further configured to send the downlink packet to the first access Ethernet device and the one or more second access Ethernet devices; and
the first access Ethernet device is further configured to determine whether a destination address of the downlink packet sent by the optical splitter is an address corresponding to the access Ethernet device and if so, receive the downlink packet.

In some optional embodiments, the system further includes one or more other optical splitters, and different optical splitters are connected to different optical modules in the core Ethernet device.

According to a twelfth aspect, an embodiment of the present application provides a data transmission method applied to a core Ethernet device, the method including:
receiving an uplink packet sent by an optical splitter; where the uplink packet is sent by a first access Ethernet device to the optical splitter within a first sending period, and the first sending period does not overlap with one or more second sending periods corresponding to one or more second access Ethernet devices connected to the optical splitter; and
sending a downlink packet to the optical splitter, so that the optical splitter sends the downlink packet to the first access Ethernet device and the one or more second access Ethernet devices.

In some optional embodiments, the method further includes:
determining historical transmission traffic of the first access Ethernet device;
based on the historical transmission traffic of the first access Ethernet device, determining a sending start time point and a sending duration for the first access Ethernet device; and
sending a first downlink packet carrying an address of the first access Ethernet device, the sending start time point, and the sending duration to the optical splitter.

In some optional embodiments, the method further includes:
at preset intervals, sending a second downlink packet carrying an address of the first access Ethernet device and a first sending time to the optical splitter, so that the first access Ethernet device, upon receiving the second downlink packet, sends a target uplink packet carrying a first receiving time and a second sending time to the optical splitter; where the first sending time is a sending time of the second downlink packet, the first receiving time is a time when the first access Ethernet device receives the second downlink packet, and the second sending time is a time when the first access Ethernet device sends the target uplink packet;
based on a second receiving time, the first sending time, the first receiving time, and the second sending time, determining a target adjustment time for the first access Ethernet device; where the second receiving time is a time when the core Ethernet device receives the target uplink packet; and
sending a third downlink packet carrying the address of the first access Ethernet device and the target adjustment time to the optical splitter, so that the first access Ethernet device, upon receiving the third downlink packet, adjusts a time of the first access Ethernet device from a current time to the corresponding target adjustment time.

In some optional embodiments, the based on a second receiving time, the first sending time, the first receiving time, and the second sending time, determining a target adjustment time for the first access Ethernet device specifically includes:
subtracting the first sending time from the second receiving time to determine a response interval;
subtracting the first receiving time from the second sending time to determine a processing duration of the first access Ethernet device;
subtracting the processing duration from the response interval to obtain an uplink and downlink round-trip time, where half of the round-trip time is a single transmission duration;
adding the single transmission duration to the first sending time to obtain a theoretical receiving time;
comparing the first receiving time with the theoretical receiving time to obtain a time error; and
determining the sum of the current time, the time error, and the single transmission duration as the target adjustment time.

According to a thirteenth aspect, an embodiment of the present application provides a data transmission method applied to an access Ethernet device, the method including:
placing an uplink packet into a packet queue in the access Ethernet device and sending the uplink packet from the packet queue to an optical splitter within a first sending period corresponding to the access Ethernet device, so that the optical splitter sends the uplink packets to a core Ethernet device; and
determining whether a destination address of a downlink packet sent by the optical splitter is an address corresponding to the access Ethernet device; and if so, receiving the downlink packet; otherwise, discarding the downlink packet; where the downlink packet is sent by the optical splitter to the access Ethernet device and one or more second access Ethernet devices connected to the optical splitter after receiving the downlink packet from the core Ethernet device; where
the first sending period does not overlap with one or more second sending periods corresponding to the one or more second access Ethernet switching devices.

In some optional embodiments, before the sending the uplink packet from the packet queue to an optical splitter within a first sending period corresponding to the access Ethernet device, the method includes:

if a current time point is within the first sending period of the access Ethernet device, sequentially retrieving uplink packets from the packet queue according to an order in which the uplink packets are stored in the packet queue and sending the retrieved uplink packets to the optical splitter.

In some optional embodiments, before the sending the uplink packet from the packet queue to an optical splitter within a first sending period corresponding to the access Ethernet device, the method further includes:
activating a light source of a second optical module of the access Ethernet device and a switch indicative of sending in a second Ethernet MAC chip of the access Ethernet device; and
after the sending the uplink packet from the packet queue to an optical splitter within a first sending period corresponding to the access Ethernet device, the method further includes:

if there are no uplink packets in the packet queue or the first sending period of the access Ethernet device ends, deactivating the switch indicative of sending in the second Ethernet MAC chip and the light source of the second optical module.

The other features and advantages of the present application will be described in the following specification, and will become apparent in part from the specification or through implementation of the present application. The objectives and other advantages of the present application can be achieved and obtained through the structures particularly pointed out in the written specification, claims, and drawings.

### BRIEF DESCRIPTION OF DRAWINGS

To more clearly illustrate the technical solutions in the embodiments of the present application or in traditional technologies, the drawings required for describing the embodiments or traditional technologies are briefly introduced below. Obviously, the drawings described below are only some embodiments of the present application, and those skilled in the art can obtain drawings of other embodiments based on these drawings without creative effort.

The drawings described herein are provided to further understand the present application and constitute a part of the present application. The exemplary embodiments and their descriptions are used to explain the present application and do not constitute an improper limitation of the present application. In the drawings:

FIG. 1 is a first system architecture diagram provided by traditional technology;

FIG. 2 is a second system architecture diagram provided by traditional technology;

FIG. 3 is a third system architecture diagram provided by traditional technology;

FIG. 4 is a system architecture diagram provided by an embodiment of the present application;

FIG. 5 is a system architecture diagram provided by an embodiment of the present application;

FIG. 6 is a system architecture diagram provided by an embodiment of the present application;

FIG. 7 is a structural diagram of a core Ethernet device provided by an embodiment of the present application;

FIG. 8 is a structural diagram of an access Ethernet device provided by an embodiment of the present application;

FIG. 9 is a schematic diagram of an uplink packet sending process provided by traditional technology;

FIG. 9a is a structural schematic diagram of a standard Ethernet frame provided by traditional technology;

FIG. 10 is a schematic diagram of an uplink packet sending process provided by an embodiment of the present application;

FIG. 11 is an interaction flowchart of a data transmission method provided by an embodiment of the present application;

FIG. 12 is an interaction flowchart of a data transmission method provided by an embodiment of the present application;

FIG. 13 is a structural schematic diagram of a data transmission apparatus provided by an embodiment of the present application;

FIG. 14 is a structural schematic diagram of a data transmission apparatus provided by an embodiment of the present application; and

FIG. 15 is a structural schematic diagram of a controller of a core Ethernet device provided by an embodiment of the present application.

### DESCRIPTION OF EMBODIMENTS

To make the objectives, technical solutions, and advantages of the embodiments of the present application clearer, the technical solutions of the present application will be described clearly and thoroughly below in conjunction with the drawings in the embodiments of the present application. Obviously, the described embodiments are part of the embodiments of the technical solutions of the present application, but not all embodiments. Based on the embodiments recorded in the present application, all other embodiments obtained by those skilled in the art without creative effort fall within the protection scope of the technical solutions of the present application.

The terms “first” and “second” in the specification, claims, and the above drawings of the present application are used to distinguish different objects and not to describe a specific order. Furthermore, the term “include” and any variations thereof are intended to cover non-exclusive protection. For example, a process, method, system, product, or device that includes a series of steps or units is not limited to the listed steps or units but may optionally include unlisted steps or units or other steps or units inherent to these processes, methods, products, or devices. “A plurality of” in the present application may mean at least two, such as two, three, or more, which is not limited by the embodiments of the present application.

In addition, the term “and/or” in this document is merely an association relationship describing associated objects, indicating that three relationships may exist. For example, A and/or B may indicate: A exists alone, A and B exist simultaneously, and B exists alone. Furthermore, the character “/” in this document, unless otherwise specified, generally indicates an “or” relationship between the associated objects.

In the description of the present application, it should be noted that, unless otherwise expressly specified and limited, the term “connection” should be understood in a broad sense, for example, as a direct connection, an indirect connection through an intermediary, a communication connection within two devices, or a communication connection between two devices. Those skilled in the art can understand the specific meaning of the above terms in the present application based on specific circumstances.

In the IEEE 802.3 protocol standard, the medium access control layer and the physical layer of Ethernet are defined. The medium access control layer employs CSMA/CD, and all stations adopting this mechanism share the transmission medium. Stations need to monitor the transmission medium and randomly delay sending packets after detecting that other stations are sending packets.

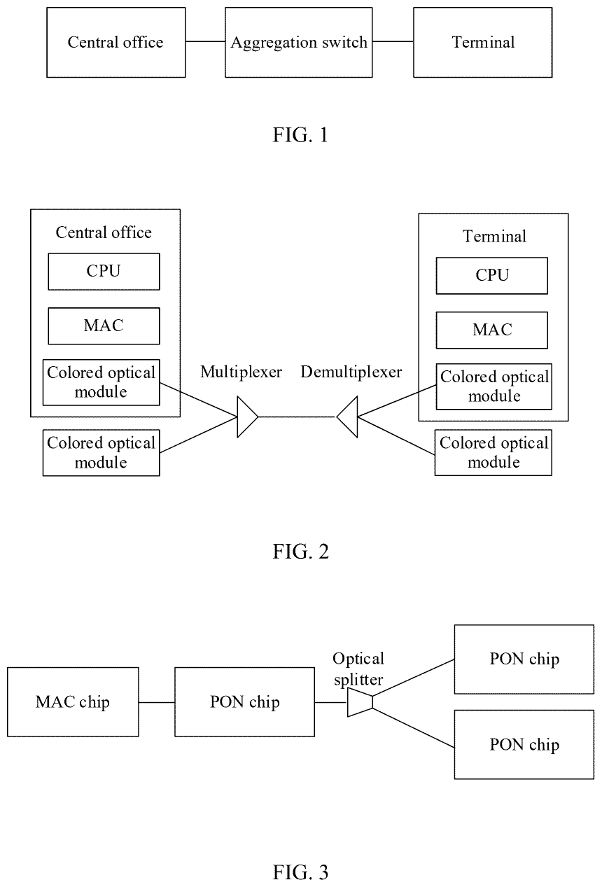

Referring to FIG. 1, devices are interconnected through switches, enabling full-duplex data exchange between stations (for example, central office devices, customer premises equipment, and the like) with exclusive transmission bandwidth. In other words, data exchange and transmission between central offices and terminals are supported through aggregation switches.

However, as the network scale grows larger, the deployment of active aggregation switches becomes increasingly complex, and the management of switches becomes more challenging

Referring to FIG. 2, passive optical exchange is achieved through wavelength division multiplexing. However, this approach requires the use of both a multiplexer and a demultiplexer, making deployment cumbersome and costly. Additionally, colored optical modules need to be installed at the terminal and central office, resulting in high deployment costs.

Referring to FIG. 3, optical splitting is performed using a PON chip. However, this approach requires external devices (for example, devices with PON chips) at both the terminal and central office sides, making deployment complex. If two chips are integrated together, they must share ports, which limits flexible port configuration and complicates the manufacturing process.

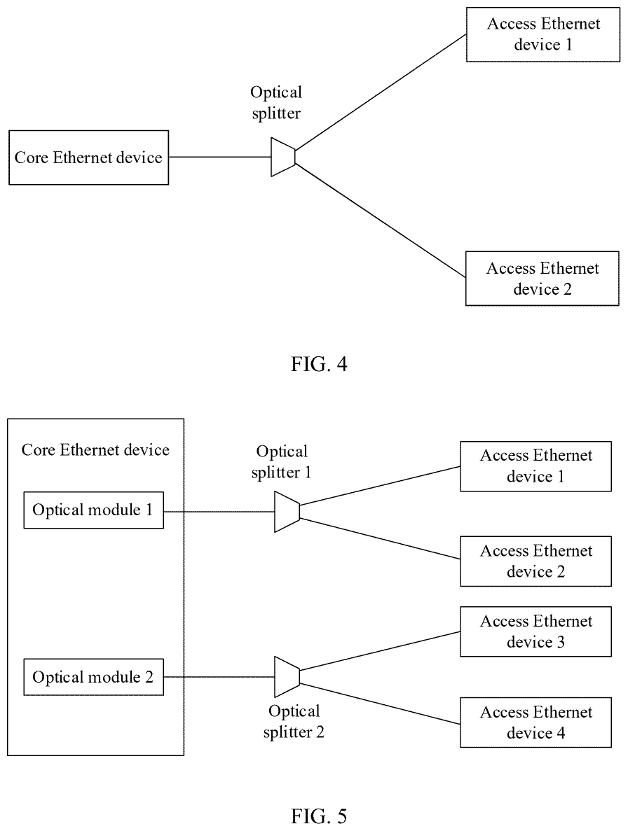

The exemplary embodiments of the present application propose a data transmission method, an Ethernet device, and a passive optical exchange system. Referring to FIG. 4, the system provided by this embodiment includes a core Ethernet device, at least one optical splitter, and multiple access Ethernet devices. Taking one optical splitter and two access Ethernet devices as shown in FIG. 4 as an example, more optical splitters and access Ethernet devices may be provided.

In some optional embodiments, the wavelength corresponding to the uplink packet and the wavelength corresponding to the downlink packet are different. Uplink and downlink packets may be transmitted over the same optical fiber. Taking FIG. 4 as an example, the core Ethernet device is connected to the optical splitter via one optical fiber, in other words, access Ethernet device 1 is connected to the optical splitter via one optical fiber, and access Ethernet device 2 is connected to the optical splitter via one optical fiber.

Referring to FIG. 5, the system may be provided with a plurality of optical splitters connected to different optical modules in the core Ethernet device, respectively. In other words, when the core Ethernet device is provided with a plurality of optical modules, it may connect to a plurality of optical splitters. The core Ethernet device in FIG. 5 is provided with two optical modules, each optical module connected to one optical splitter. In other embodiments, the core Ethernet device may be equipped with more optical modules, a part of the optical modules may be connected to optical splitters while another part of the optical modules are not connected to optical splitters, which is not specifically limited by the present application.

The core Ethernet device or access Ethernet device determines, based on the identifier of its optical module, whether the optical module is a traditional optical module (for example, a colored optical module) or an optical module in the embodiments of the present application. If it is a traditional optical module, a traditional data forwarding mechanism (CSMA/CD access mechanism) is used. If it is an optical module in the embodiments of the present application, the data forwarding mechanism in the embodiments of the present application is used.

In one embodiment, the access Ethernet device is configured to send the uplink packet to a corresponding optical splitter within a corresponding sending period; where the sending period is allocated by the core Ethernet device for each access Ethernet device connected to the optical splitter, and the sending periods corresponding to access Ethernet devices connected to the optical splitter do not overlap;
the optical splitter is configured to send the uplink packet to the core Ethernet device;
the core Ethernet device is further configured to send a downlink packet to the corresponding optical splitter;
the optical splitter is further configured to send the downlink packet to each connected access Ethernet device; and
the access Ethernet device is further configured to determine whether a destination address of the downlink packet sent by the optical splitter is an address corresponding to the access Ethernet device; if so, receive the downlink packet; otherwise, discard the downlink packet.

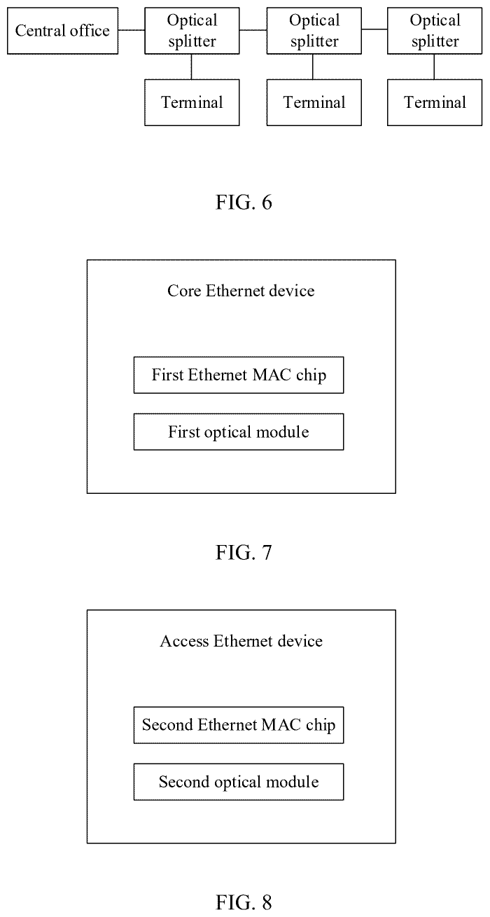

Referring to FIG. 6, multi-level optical splitting may also be achieved through a plurality of optical splitters in implementation. That is, an optical splitter may be connected to another optical splitter, achieving multi-level optical splitting through the cascading of optical splitters.

The above scheme does not require a PON chip. Instead, packets in Ethernet frame format utilize the MAC chip of network devices in traditional network architectures to achieve passive optical transmission between Ethernet network devices, with the optical splitter enabling passive optical splitting. Additionally, downlink packets are sent via broadcasting, instead of processing packets in Ethernet frame format into PON frame format, managing uplink packet transmission to ensure that the sending periods of the access devices do not overlap. In other words, different access Ethernet devices transmit uplink packets in different sending periods, and each access Ethernet device sends uplink packets only within its corresponding sending period, without deploying active switches between customer premises equipment and central office devices for data exchange and transmission. The optical splitter performs passive optical splitting, avoiding uplink packet collisions during passive optical splitting. This embodiment does not require additional external chips or modifications to packets in Ethernet frame format, enabling passive optical splitting.

The technical solutions of the present application and how the technical solutions of the present application address the above technical problems will be described in detail below with reference to the drawings and specific embodiments. The following specific embodiments may be combined with each other, and the same or similar concepts or processes may not be repeated in some embodiments.

Referring to FIG. 7, a core Ethernet device provided by an embodiment of the present application includes a first Ethernet MAC chip and a first optical module connected to the first Ethernet MAC chip, where:
the first optical module is configured to receive an uplink packet sent by an optical splitter; the uplink packet is sent by an access Ethernet device to the optical splitter within a corresponding sending period, and the sending periods corresponding to access Ethernet devices connected to the optical splitter do not overlap.

In implementation, the MAC layer adopts the CSMA/CD access mechanism. If this mechanism is used, multiple access Ethernet devices may experience packet collisions when sending uplink packets to the optical splitter.

Based on this, this embodiment allocates different sending periods to different access Ethernet devices, using a time division multiple access (TDMA) mechanism for uplink transmission. An access Ethernet device does not send uplink packets beyond its sending periods, reducing collisions with uplink packets sent by other access Ethernet devices.

If a PON chip is used, packets in Ethernet frame format need to be processed into PON frame format packets. In the exemplary embodiments of the present application, the transmitted packets are all in standard Ethernet frame format, without modifying the packet format. Instead, high-precision time synchronization is achieved by calculating time based on the Ethernet time synchronization protocol, and the core Ethernet device delivers non-overlapping sending periods to access Ethernet devices. Each access Ethernet device sends uplink packets based on its assigned sending period. By modifying the CSMA/CD mechanism of the MAC layer for sending uplink packets to a TDMA mechanism, time-division sending for each access Ethernet device is achieved, thereby enabling optical transmission.

After performing optoelectronic conversion on the received uplink packet, the first optical module sends the converted uplink packet to the first Ethernet MAC chip for processing.

The first Ethernet MAC chip is configured to transmit a downlink packet to the first optical module; and the first optical module is further configured to send the downlink packet to the optical splitter, so that the optical splitter sends the downlink packet to each connected access Ethernet device.

In implementation, the MAC layer adopts the CSMA/CD access mechanism, and with this mechanism, no packet collisions occur during the transmission of downlink packets. Based on this, this embodiment may send downlink packets using a downlink broadcasting method.

In this embodiment, the first Ethernet MAC chip transmits the downlink packet to the first optical module, and the first optical module sends the downlink packet to the optical splitter. Upon receiving the downlink packet, the optical splitter needs to send the downlink packet to each connected access Ethernet device, so that each access Ethernet device can receive the downlink packet.

In some optional embodiments, the first Ethernet MAC chip in the core Ethernet device is further configured to:
determine historical transmission traffic of each access Ethernet device;
based on the historical transmission traffic of all access Ethernet devices, determine a sending start time point and a sending duration for each access Ethernet device; and
transmit a first downlink packet carrying an address of an access Ethernet device, the corresponding sending start time point, and the sending duration to the first optical module.

In implementation, since each access Ethernet device can only transmit uplink packets within its corresponding sending period, to meet the data transmission needs of each access Ethernet device as much as possible, it is necessary to reasonably allocate sending periods for each access Ethernet device.

The historical transmission traffic of each access Ethernet device reflects the sending requirements of the access Ethernet device, such as how often data transmission is needed and how long each data transmission takes. Based on this, the core Ethernet device in this embodiment considers the historical transmission traffic of all access Ethernet devices, that is, the distribution of previous transmission traffic, when allocating sending periods.

The above scheme reflects the sending requirements of each access Ethernet device through the historical transmission traffic, such as how often data transmission is needed and how long each data transmission takes. Based on the historical transmission traffic of all access Ethernet devices, the sending start time point and sending duration (that is, the corresponding sending period) for each access Ethernet device can be reasonably determined. Subsequently, the first downlink packet carrying the address of the access Ethernet device, the corresponding sending start time point, and the sending duration is transmitted to the optical splitter, enabling the corresponding access Ethernet device to obtain its sending period.

In some optional embodiments, the first Ethernet MAC chip is further configured to:
at preset intervals, transmit a second downlink packet carrying the address of an access Ethernet device and a first sending time to the first optical module, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determine a target adjustment time for the corresponding access Ethernet device; where the second receiving time is a time when the core Ethernet device receives the target uplink packet; and
transmit a third downlink packet carrying the address of the access Ethernet device and the corresponding target adjustment time to the first optical module, so that the corresponding access Ethernet device, upon receiving the third downlink packet, adjusts a clock module from a current time to the corresponding target adjustment time.

In implementation, since access Ethernet devices need to reference time to send uplink packets, a unified time standard is required on the access Ethernet device side. If the time standards among different access Ethernet devices differ significantly, uplink packet collisions may still occur.

Based on this, this embodiment performs time correction for each access Ethernet device at preset intervals.

For example, the core Ethernet device subtracts the first sending time from the second receiving time to determine a response interval; the core Ethernet device subtracts the first receiving time from the second sending time to determine a processing duration of the access Ethernet device; subtracts the processing duration from the response interval to obtain an uplink and downlink round-trip time, where half of the round-trip time is a single transmission duration; the core Ethernet device adds the single transmission duration to the first sending time to obtain a theoretical receiving time; compares the first receiving time with the theoretical receiving time to obtain a time error; and determines a sum of the current time, the time error, and the single transmission duration as the target adjustment time.

The above method for determining the target adjustment time is exemplary, and other methods may be used in implementation to determine the target adjustment time, which will not be repeated here.

The above scheme, through periodic interactions involving packets carrying time information between the core Ethernet device and each access Ethernet device at preset intervals, achieves time correction for each access Ethernet device, ensuring a unified time standard among access Ethernet devices and further reducing the occurrence of uplink packet collisions.

Referring to FIG. 8, an access Ethernet device provided by an embodiment of the present application includes a second Ethernet MAC chip and a second optical module connected to the second Ethernet MAC chip.

The second Ethernet MAC chip is configured to place an uplink packet into a packet queue; and within a sending period corresponding to the access Ethernet device, sequentially retrieve uplink packets from the packet queue and transmit the uplink packets to the second optical module; where the uplink packets are packets in standard Ethernet frame format.

The second optical module is configured to send the uplink packets to an optical splitter, so that the optical splitter sends the uplink packets to a core Ethernet device.

In traditional technology, the MAC layer adopts the CSMA/CD access mechanism. If this mechanism is used, multiple access Ethernet devices may experience packet collisions when sending uplink packets to the optical splitter.

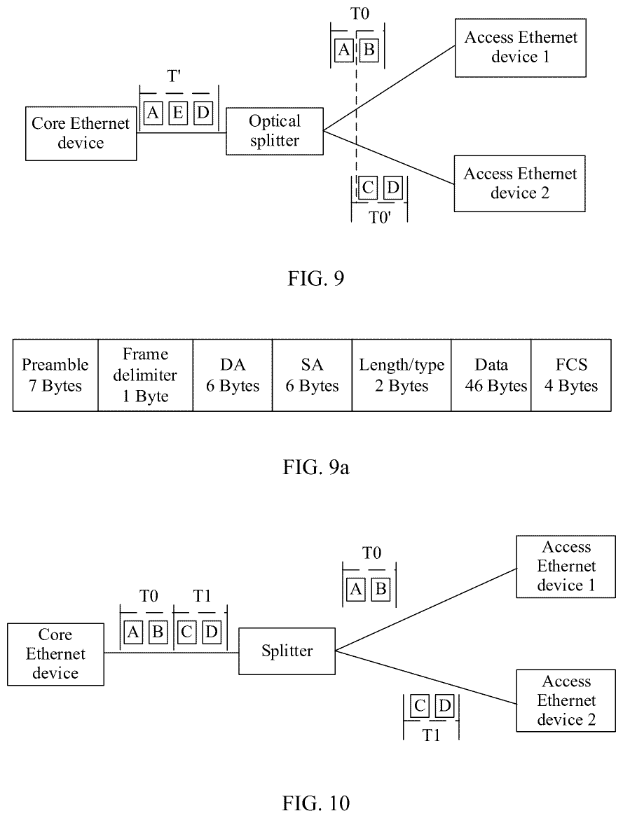

Referring to FIG. 9, when access Ethernet device 1 sends uplink packet 1 (including data A+data B) at time point T0, access Ethernet device 2 sends uplink packet 2 (including data C+data D) at time point T0′. There is an overlap between T0 and T0′, causing a collision between data B and data C, resulting in erroneous data E. Thus, the uplink packet sent to the core Ethernet device through the optical splitter includes data A+data E+data D, instead of the aforementioned uplink packet 1 and uplink packet 2.

Based on this, in the embodiments of the present application, the core Ethernet device allocates different sending periods to different access Ethernet devices, using a time division multiple access (TDMA) mechanism for uplink transmission.

Upon receiving an uplink packet, the second Ethernet MAC chip of the access Ethernet device does not send the uplink packet immediately but places it into a packet queue. The uplink packet is sent only within the sending period, and no uplink packets are sent outside the sending period, reducing collisions with uplink packets sent by other access Ethernet devices.

The embodiments of the present application do not limit the specific implementation of the packet queue, such as hardware queues, software queues, or a combination of hardware and software queues. In the embodiments of the present application, the uplink and/or downlink packets transmitted in the uplink and/or downlink are all packets in standard Ethernet frame format.

FIG. 9a illustrates an embodiment of the structure of a standard Ethernet frame, including the Institute of Electrical and Electronics Engineers (IEEE) 802.3 format and Ethernet II format.

The starting part of both Ethernet frames consists of a preamble and a frame delimiter, where the preamble is 7 bytes (Bytes) long, and the frame delimiter is 1 byte long.

This is followed by DA, SA, and length/type; where DA is the destination MAC address, 6 bytes long, used to identify the recipient of the frame; SA is the source MAC address, 6 bytes long, used to identify the sender of the frame; and the length/type (Type/Length) field value distinguishes the type of the two frames: when the length/type field value is less than or equal to 1500 (hexadecimal: 0x05DC), the Ethernet frame uses the IEEE 802.3 format; and when the length/type field value is greater than or equal to 1536 (hexadecimal: 0x0600), the Ethernet frame uses the Ethernet II format.

Then, the frame's payload (including data and/or padding) is at least 46 bytes long. Finally, it ends with a frame check sequence (FCS), which is 4 bytes long and used to check whether data transmission is damaged.

Referring to FIG. 10, this embodiment allocates sending period T0 to access Ethernet device 1 and sending period T1 to access Ethernet device 2, with no overlap between T0 and T1. Access Ethernet device 1 sends uplink packet 1 (including data A+data B) at T0, and access Ethernet device 2 sends uplink packet 2 (including data C+data D) at T1. Since there is no overlap between T0 and T1, uplink packet 1 and uplink packet 2 do not collide, allowing the optical splitter to send both uplink packet 1 and uplink packet 2 to the core Ethernet device.

The second optical module is further configured to determine whether a destination address of a downlink packet sent by the optical splitter is an address corresponding to the access Ethernet device; and if so, receive the downlink packet; otherwise, discard the downlink packet; where the downlink packet is sent by the optical splitter to each connected access Ethernet device after receiving the downlink packet from the core Ethernet device; where the sending periods corresponding to each access Ethernet switching device connected to the optical splitter do not overlap.

As described above, this embodiment sends downlink packets using a downlink broadcasting method. Upon receiving a downlink packet, the optical splitter needs to send the downlink packet to each connected access Ethernet device, and the access Ethernet device only needs to receive its own downlink packet. Based on this, the access Ethernet device needs to determine whether the destination address of the downlink packet is its own address; if it is its own address, indicating that the downlink packet is sent by the core Ethernet device to itself, the downlink packet is received; otherwise, indicating that the downlink packet is sent by the core Ethernet device to other access Ethernet devices, the downlink packet is discarded.

In some optional embodiments, the second Ethernet MAC chip is specifically configured to:
if a current time point is within the sending period of the access Ethernet device, sequentially retrieve uplink packets from the packet queue according to an order in which the uplink packets are stored.

For example, to avoid uplink packet collisions, the access Ethernet device cannot send uplink packets at any time but only within its corresponding sending period. Therefore, uplink packets need to be placed in a packet queue for caching. If the current time point is within the corresponding sending period, uplink packets are retrieved from the packet queue in the order they were stored and sent to the optical splitter; if the current time point is not within the corresponding sending period, it needs to wait for the next sending period.

The above scheme caches uplink packets in a packet queue. If the current time point is within the corresponding sending period, uplink packets are retrieved from the packet queue in the order they were stored and sent to the optical splitter, reducing uplink packet collisions and enabling orderly transmission of uplink packets.

In some optional embodiments, before sequentially retrieving uplink packets from the packet queue, the second Ethernet MAC chip is further configured to:
activate a light source of the second optical module and a switch indicative of sending in the second Ethernet MAC chip; and
after the second optical module sends the uplink packet to the optical splitter, the second Ethernet MAC chip is further configured to:
if there are no uplink packets in the packet queue or the sending period of the access Ethernet device ends, deactivate the switch indicative of sending in the second Ethernet MAC chip and the light source of the second optical module.

For example, the switch indicative of sending is a circuit switch (for example, an enable switch of a register) provided on a transmission circuit (including the transmission circuit of the MAC layer and the transmission circuit of the physical layer). For example, the switch indicative of sending may be implemented by programmatically controlling the enabling or disabling of a register with transmission functionality.

In implementation, if the light source of the optical module and the switch indicative of sending of the access Ethernet device remains activated, the access Ethernet device side will send empty packets, which may cause optical interference with normal data packets.

Based on this, this embodiment activates the switch indicative of sending and the light source of the optical module only when the access Ethernet device needs to send data. After determining that no further data needs to be sent, this embodiment deactivates the switch indicative of sending in the second Ethernet MAC chip and the light source of the second optical module.

Since the access Ethernet device has a packet queue, there may be uplink packets remaining in the packet queue during transmission. In some optional embodiments, the light source of the second optical module is activated first, followed by the switch indicative of sending in the second Ethernet MAC chip. By activating the light source of the second optical module when the access Ethernet device needs to send data, if there are uplink packets remaining in the packet queue, the uplink packets in the packet queue can be sent immediately, improving transmission efficiency.

In some optional embodiments, when no data needs to be sent, the switch indicative of sending in the second Ethernet MAC chip is deactivated first, followed by the light source of the second optical module, ensuring that no new uplink packets arrive at the second optical module.

The above scheme activates the light source of the second optical module when the access Ethernet device needs to send data, followed by activating the switch indicative of sending in the second Ethernet MAC chip. After the access Ethernet device determines that no further data needs to be sent (that is, there are no uplink packets in the packet queue or the corresponding sending period has ended), the switch indicative of sending in the second Ethernet MAC chip is deactivated, followed by deactivating the light source of the second optical module. This ensures that, during the entire sending process, the switch indicative of sending in the second Ethernet MAC chip remains activated and the light source of the second optical module remains on, enabling the transmission of uplink packets. Outside the sending process, the switch indicative of sending in the second Ethernet MAC chip remains deactivated, and the light source of the second optical module remains off, reducing the transmission of empty packets from the access Ethernet device and minimizing optical interference with other access Ethernet devices. By controlling the switch indicative of sending and the light source of the optical module, packet transmission may be achieved without any format changes, packet integration, or packet splitting of the packets in the packet queue, eliminating the need for external chips or CPU-based processing of specific packet operations, reducing costs while improving uplink packet processing efficiency.

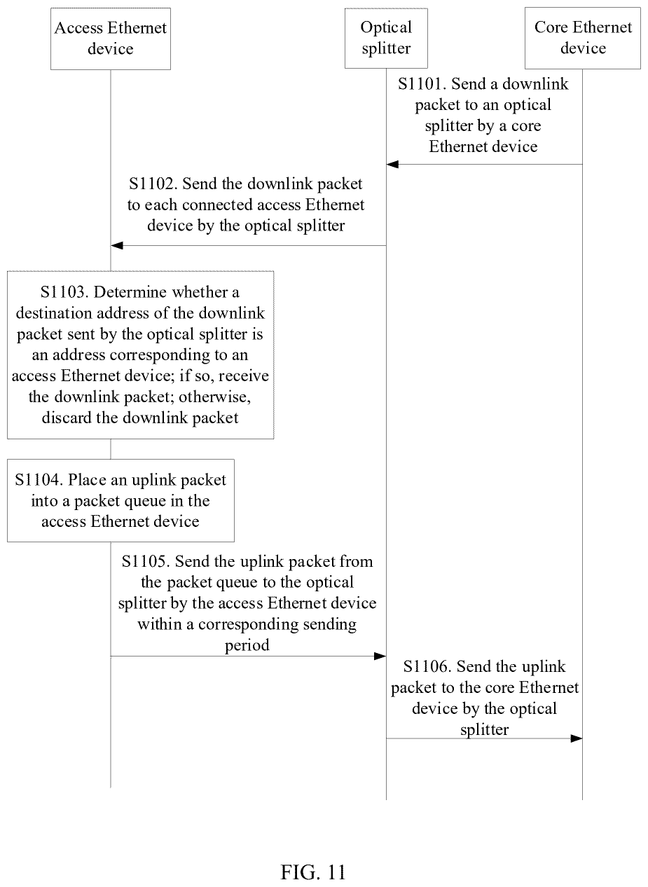

FIG. 11 is an interaction flowchart of a first data transmission method provided by an embodiment of the present application, as shown in FIG. 11, including the following steps:

Step S1101: A core Ethernet device sends a downlink packet to the optical splitter.

Step S1102: The optical splitter sends the downlink packet to each connected access Ethernet device.

Step S1103: An access Ethernet device determines whether a destination address of the downlink packet sent by the optical splitter is an address corresponding to the access Ethernet device; if so, receive the downlink packet; otherwise, discard the downlink packet.

Step S1104: The access Ethernet device places an uplink packet into a packet queue in the access Ethernet device.

Step S1105: The access Ethernet device sends the uplink packet from the packet queue to the optical splitter within a corresponding sending period.

Step S1106: The optical splitter sends the uplink packet to the core Ethernet device.

Steps S1101 to S1103 are the transmission process of the downlink packet, and steps S1104 to S1106 are the transmission process of the uplink packet. The transmission processes of uplink and downlink packets do not affect each other and do not have a necessary sequential order.

The above scheme achieves passive optical splitting through the optical splitter. Downlink packets are transmitted via broadcasting, and uplink packets are transmitted using a time division multiple access method. Different access Ethernet devices correspond to different sending periods, and each access Ethernet device sends uplink packets only within its corresponding sending period. In other words, different access Ethernet devices send uplink packets within different sending periods, reducing uplink packet collisions during passive optical splitting through the optical splitter. This embodiment does not require additional external chips, enabling passive optical splitting.

In some optional embodiments, the above step S1105 may be implemented as follows:
if a current time point is within the sending period of the access Ethernet device, sequentially retrieve uplink packets from the packet queue according to an order in which the uplink packets are stored in the packet queue and send the retrieved uplink packets to the optical splitter.

The above scheme caches uplink packets in a packet queue. If the current time point is within the corresponding sending period, uplink packets are retrieved from the packet queue in the order they were stored and sent to the optical splitter, reducing uplink packet collisions and enabling orderly transmission of uplink packets.

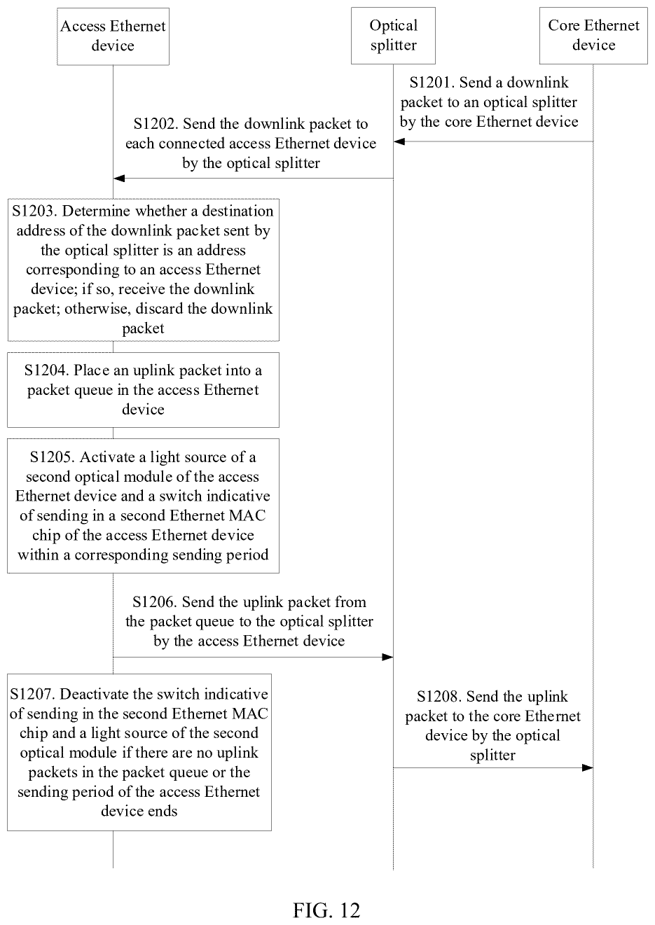

FIG. 12 is an interaction flowchart of a data transmission method provided by an embodiment of the present application, as shown in FIG. 12, including the following steps:

Step S1201: A core Ethernet device sends a downlink packet to the optical splitter.

Step S1202: The optical splitter sends the downlink packet to each connected access Ethernet device.

Step S1203: An access Ethernet device determines whether a destination address of the downlink packet sent by the optical splitter is an address corresponding to the access Ethernet device; if so, receive the downlink packet; otherwise, discard the downlink packet.

Step S1204: The access Ethernet device places an uplink packet into a packet queue in the access Ethernet device.

Step S1205: Within a corresponding sending period, the access Ethernet device activates a light source of a second optical module of the access Ethernet device and a switch indicative of sending in a second Ethernet MAC chip of the access Ethernet device.

Step S1206: The access Ethernet device sends the uplink packet from the packet queue to the optical splitter.

Step S1207: If there are no uplink packets in the packet queue or the sending period of the access Ethernet device ends, the access Ethernet device deactivates the switch indicative of sending in the second Ethernet MAC chip and the light source of the second optical module.

Step S1208: The optical splitter sends the uplink packet to the core Ethernet device.

There is no logical relationship between step S1207 and step S1208, that is, this embodiment does not limit the execution order of S1207 and S1208.

Steps S1201 to S1203 are the transmission process of the downlink packet, and steps S1204 to S1208 are the transmission process of the uplink packet. The transmission processes of uplink and downlink packets do not affect each other and do not have a necessary sequential order.

The above scheme activates the light source of the second optical module when the access Ethernet device needs to send data, followed by activating the switch indicative of sending in the second Ethernet MAC chip. After the access Ethernet device determines that no further data needs to be sent (that is, there are no uplink packets in the packet queue or the corresponding sending period has ended), the switch indicative of sending in the second Ethernet MAC chip is deactivated, followed by deactivating the light source of the second optical module. This ensures that, during the entire sending process, the switch indicative of sending in the second Ethernet MAC chip remains activated and the light source of the second optical module remains on, enabling the transmission of uplink packets. Outside the sending process, the switch indicative of sending in the second Ethernet MAC chip remains deactivated, and the light source of the second optical module remains off, reducing the transmission of empty packets from the access Ethernet device and minimizing optical interference with other access Ethernet devices.

In some optional embodiments, based on the above data transmission interaction method, before step S1101, the core Ethernet device further performs the following steps:
determining historical transmission traffic of each access Ethernet device; and
based on the historical transmission traffic of all access Ethernet devices, determining a sending start time point and a sending duration for each access Ethernet device;

Step S1101 is specifically implemented as follows:
sending a first downlink packet carrying an address of the access Ethernet device, the corresponding sending start time point, and the sending duration to the optical splitter.

The above scheme reflects the sending requirements of each access Ethernet device through the historical transmission traffic of each access Ethernet device, such as how often data transmission is needed and how long each data transmission takes. Based on the historical transmission traffic of all access Ethernet devices, the sending start time point and sending duration (that is, the corresponding sending period) for each access Ethernet device can be reasonably determined. Subsequently, the first downlink packet carrying the address of the access Ethernet device, the corresponding sending start time point, and the sending duration is transmitted to the optical splitter, enabling the corresponding access Ethernet device to obtain its sending period.

In some optional embodiments, based on the above data transmission interaction method, the core Ethernet device further performs the following steps:
at preset intervals, sending a second downlink packet carrying an address of the access Ethernet device and a first sending time to the optical splitter, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determining a target adjustment time for the corresponding access Ethernet device; where the second receiving time is a time when the core Ethernet device receives the target uplink packet; and
sending a third downlink packet carrying the address of the access Ethernet device and the corresponding target adjustment time to the optical splitter, so that the corresponding access Ethernet device, upon receiving the third downlink packet, adjusts a clock module from a current time to the corresponding target adjustment time.

It can be understood that steps S1101 to S1103 are the transmission process of the downlink packet, steps S1104 to S1106 are the transmission process of the uplink packet, and the above steps are the time adjustment process. The uplink process, downlink process, and time adjustment process do not affect each other.

The above scheme, through periodic interactions involving packets carrying time information between the core Ethernet device and each access Ethernet device at preset intervals, achieves time correction for each access Ethernet device, ensuring a unified time standard among access Ethernet devices and further reducing the occurrence of uplink packet collisions.

The specific implementation of the above interaction process may refer to the implementation of the core Ethernet device and the access Ethernet device, and repeated details will not be described here.

In the embodiments of the present application, the data transmission method performed by the core Ethernet device includes the following steps:
receiving an uplink packet sent by an optical splitter; the uplink packet is sent by an access Ethernet device to the optical splitter within a corresponding sending period, and the sending periods corresponding to access Ethernet devices connected to the optical splitter do not overlap; and
sending a downlink packet to the optical splitter, so that the optical splitter sends the downlink packet to each connected access Ethernet device.

In some optional embodiments, the method further includes:
determining historical transmission traffic of each access Ethernet device;
based on the historical transmission traffic of all access Ethernet devices, determining a sending start time point and a sending duration for each access Ethernet device; and
sending a first downlink packet carrying an address of an access Ethernet device, the corresponding sending start time point, and the sending duration to the optical splitter.

In some optional embodiments, the method further includes:
at preset intervals, sending a second downlink packet carrying an address of the access Ethernet device and a first sending time to the optical splitter, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determining a target adjustment time for the corresponding access Ethernet device; where the second receiving time is a time when the core Ethernet device receives the target uplink packet; and
sending a third downlink packet carrying the address of the access Ethernet device and the corresponding target adjustment time to the optical splitter, so that the corresponding access Ethernet device, upon receiving the third downlink packet, adjusts a clock module from a current time to the corresponding target adjustment time.

The specific implementation of the above embodiment may refer to the implementation of the core Ethernet device described above, and repeated details will not be described here.

In the embodiments of the present application, the data transmission method performed by the second Ethernet MAC chip of the access Ethernet device includes the following steps:
placing an uplink packet into a packet queue in the access Ethernet device and sending the uplink packet from the packet queue to an optical splitter within a corresponding sending period, so that the optical splitter sends the uplink packets to a core Ethernet device; and
determining whether a destination address of a downlink packet sent by the optical splitter is an address corresponding to the access Ethernet device; and if so, receiving the downlink packet; otherwise, discarding the downlink packet; where the downlink packet is sent by the optical splitter to each connected access Ethernet device after receiving the downlink packet from the core Ethernet device; where
the sending periods corresponding to access Ethernet switching devices connected to the optical splitter do not overlap.

In some optional embodiments, the sending the uplink packet from the packet queue to an optical splitter within a sending period corresponding to the access Ethernet device includes:
if a current time point is within the sending period of the access Ethernet device, sequentially retrieving uplink packets from the packet queue according to an order in which the uplink packets are stored in the packet queue and sending the retrieved uplink packets to the optical splitter.

In some optional embodiments, before the sending the uplink packet from the packet queue to an optical splitter within a sending period corresponding to the access Ethernet device, the method further includes:
activating a light source of a second optical module of the access Ethernet device and a switch indicative of sending in a second Ethernet MAC chip of the access Ethernet device; and
after the sending uplink packets from the packet queue to an optical splitter within a sending period corresponding to the access Ethernet device, the method further includes:
if there are no uplink packets in the packet queue or the sending period of the access Ethernet device ends, deactivating the switch indicative of sending in the second Ethernet MAC chip and the light source of the second optical module.

The specific implementation of the above embodiment may refer to the implementation of the access Ethernet device described above, and repeated details will not be described here.

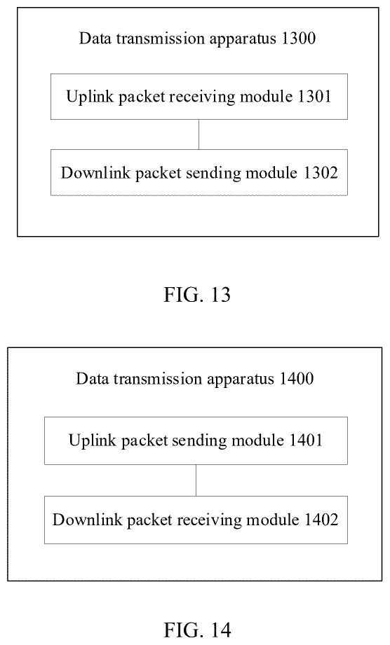

As shown in FIG. 13, based on the same inventive concept as the data transmission method on the core Ethernet device side, an embodiment of the present application provides a first data transmission apparatus 1300 applied to a core Ethernet device, the apparatus including:
an uplink packet receiving module 1301 configured to receive an uplink packet sent by an optical splitter; the uplink packet is sent by an access Ethernet device to the optical splitter within a corresponding sending period, and the sending periods corresponding to access Ethernet devices connected to the optical splitter do not overlap; and
a downlink packet sending module 1302 configured to send a downlink packet to the optical splitter, so that the optical splitter sends the downlink packet to each connected access Ethernet device.

In some optional embodiments, the downlink packet sending module 1302 is further configured to:
determine historical transmission traffic of each access Ethernet device;
based on the historical transmission traffic of all access Ethernet devices, determine a sending start time point and a sending duration for each access Ethernet device; and
send a first downlink packet carrying an address of an access Ethernet device, the corresponding sending start time point, and the sending duration to the optical splitter.

In some optional embodiments, the downlink packet sending module 1302 is further configured to:
at preset intervals, send a second downlink packet carrying the address of the access Ethernet device and a first sending time to the optical splitter, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determine a target adjustment time for the corresponding access Ethernet device; where the second receiving time is a time when the core Ethernet device receives the target uplink packet; and
send a third downlink packet carrying the address of the access Ethernet device and the corresponding target adjustment time to the optical splitter, so that the corresponding access Ethernet device, upon receiving the third downlink packet, adjusts a clock module from a current time to the corresponding target adjustment time.

The specific implementation of the above embodiment may refer to the implementation of the core Ethernet device described above, and repeated details will not be described here.

As shown in FIG. 14, based on the same inventive concept as the data transmission method on the access Ethernet device side, an embodiment of the present application provides a second data transmission apparatus 1400 applied to an access Ethernet device, the apparatus including:
an uplink packet sending module 1401 configured to place an uplink packet into a packet queue in the access Ethernet device and send the uplink packet from the packet queue to an optical splitter within a sending period corresponding to the access Ethernet device, so that the optical splitter sends the uplink packets to a core Ethernet device; and
a downlink packet receiving module 1402 configured to determine whether a destination address of a downlink packet sent by the optical splitter is an address corresponding to the access Ethernet device; and if so, receive the downlink packet; otherwise, discard the downlink packet; where the downlink packet is sent by the optical splitter to each connected access Ethernet device after receiving the downlink packet sent from the core Ethernet device; where
the sending periods corresponding to access Ethernet switching devices connected to the optical splitter do not overlap.

In some optional embodiments, the uplink packet sending module 1401 is specifically configured to:
if a current time point is within the sending period of the access Ethernet device, sequentially retrieve uplink packets from the packet queue according to an order in which the uplink packets are stored in the packet queue and send the retrieved uplink packets to the optical splitter.

In some optional embodiments, the uplink packet sending module 1401 is further configured to:
before the sending the uplink packet from the packet queue to an optical splitter within a sending period corresponding to the access Ethernet device, activate a light source of a second optical module of the access Ethernet device and a switch indicative of sending in a second Ethernet MAC chip of the access Ethernet device; and
after the sending the uplink packet from the packet queue to an optical splitter within a sending period corresponding to the access Ethernet device, if there are no uplink packets in the packet queue or the sending period of the access Ethernet device ends, deactivate the switch indicative of sending in the second Ethernet MAC chip and the light source of the second optical module.

The specific implementation of the above embodiment may refer to the implementation of the access Ethernet device described above, and repeated details will not be described here.

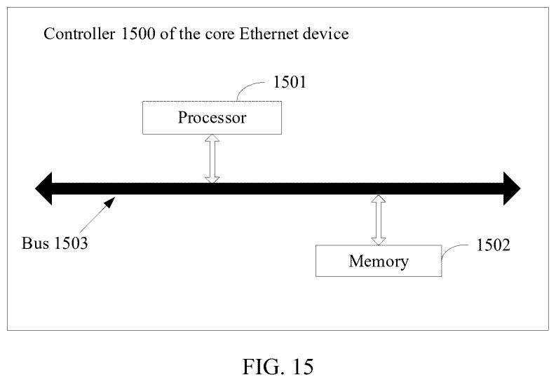

Based on the same technical concept, an embodiment of the present application further provides a controller 1500 of a core Ethernet device, as shown in FIG. 15, including at least one processor 1501 and a memory 1502 connected to the at least one processor. The embodiments of the present application do not limit the specific connection medium between the processor 1501 and the memory 1502. In FIG. 15, the processor 1501 and the memory 1502 are connected via a bus 1503 as an example. The bus may be divided into an address bus, a data bus, a control bus, and the like. For ease of illustration, FIG. 15 uses a single thick line to represent the bus, but this does not indicate that there is only one bus or one type of bus.

The processor 1501 is the control center of the controller of the core Ethernet device, capable of connecting various parts of the controller of the core Ethernet device using various interfaces and lines, and achieving data processing by running or executing instructions stored in the memory 1502 and calling data stored in the memory 1502. Optionally, the processor 1501 may include one or more processing units, and the processor 1501 may integrate an application processor and a modem processor, where the application processor primarily handles operating systems, user interfaces, and applications, and the modem processor primarily handles issuing instructions. It can be understood that the modem processor may not be integrated into the processor 1501. In some embodiments, the processor 1501 and the memory 1502 may be implemented on the same chip, while in other embodiments, they may be implemented on separate chips.

The processor 1501 may be a general-purpose processor, such as a digital signal processor, an application specific integrated circuit (ASIC), a field programmable gate array, or other programmable logic devices, discrete gate or transistor logic devices, or discrete hardware components, capable of implementing or executing the methods, steps, and logic block diagrams disclosed in the embodiments of the present application. The general-purpose processor may be a microprocessor or any conventional processor, and the like. The steps of the method disclosed in combination with the embodiments of the data transmission method may be directly embodied as executed by a hardware processor or executed by a combination of hardware and software modules in the processor.

The memory 1502 as a non-volatile computer-readable storage medium is configured to store non-volatile software programs, non-volatile computer-executable programs, and modules. The memory 1502 may include at least one type of storage medium, such as flash memory, hard disk, multimedia card, card-type memory, random access memory (RAM), static random access memory (SRAM), programmable read-only memory (PROM), read-only memory (ROM), electrically erasable programmable read-only memory (EEPROM), magnetic memory, magnetic disk, optical disk, and the like. The memory 1502 is any other medium capable of carrying or storing desired program code in the form of instructions or data structures and accessible by a computer, but is not limited thereto. The memory 1502 in the embodiments of the present application may also be a circuit or any other device capable of implementing a storage function, used to store program instructions and/or data.

In the embodiments of the present application, the memory 1502 stores a computer program, and when the program is executed by the processor 1501, the processor 1501 is caused to execute:
receiving an uplink packet sent by an optical splitter; where the uplink packet is sent by an access Ethernet device to the optical splitter within a corresponding sending period, and the sending periods corresponding to access Ethernet devices connected to the optical splitter do not overlap; and sending a downlink packet to the optical splitter, so that the optical splitter sends the downlink packet to each connected access Ethernet device.

In some optional embodiments, the processor 1501 further executes:
determining historical transmission traffic of each access Ethernet device;
based on the historical transmission traffic of all access Ethernet devices, determining a sending start time point and a sending duration for each access Ethernet device; and
sending a first downlink packet carrying an address of the access Ethernet device, the corresponding sending start time point, and the sending duration to the optical splitter.

In some optional embodiments, the processor 1501 further executes:
at preset intervals, sending a second downlink packet carrying an address of the access Ethernet device and a first sending time to the optical splitter, so that the corresponding access Ethernet device, upon receiving the second downlink packet, sends a target uplink packet carrying a first receiving time and a second sending time to the optical splitter; where the first sending time is a sending time of the second downlink packet, the first receiving time is a time when the corresponding access Ethernet device receives the second downlink packet, and the second sending time is a time when the corresponding access Ethernet device sends the target uplink packet;
based on a second receiving time, the first sending time, the first receiving time, and the second sending time, determining a target adjustment time for the corresponding access Ethernet device; where the second receiving time is a time when the core Ethernet device receives the target uplink packet; and
sending a third downlink packet carrying the address of the access Ethernet device and the corresponding target adjustment time to the optical splitter, so that the corresponding access Ethernet device, upon receiving the third downlink packet, adjusts a clock module from a current time to the corresponding target adjustment time.

Based on the same technical concept, an embodiment of the present application further provides a controller of an access Ethernet device, including at least one processor and at least one memory, where the memory stores a computer program, and when the program is executed by the processor, the processor is caused to execute:
placing an uplink packet into a packet queue in the access Ethernet device and sending the uplink packet from the packet queue to an optical splitter within a corresponding sending period, so that the optical splitter sends the uplink packets to a core Ethernet device;
determining whether a destination address of a downlink packet sent by the optical splitter is an address corresponding to the access Ethernet device; and if so, receiving the downlink packet; otherwise, discarding the downlink packet; where the downlink packet is sent by the optical splitter to each connected access Ethernet device after receiving the downlink packet from the core Ethernet device; where
the sending periods corresponding to access Ethernet switching devices connected to the optical splitter do not overlap.

In some optional embodiments, the processor specifically executes:
if a current time point is within the sending period of the access Ethernet device, sequentially retrieving uplink packets from the packet queue according to an order in which the uplink packets are stored in the packet queue and sending the retrieved uplink packets to the optical splitter.

In some optional embodiments, the processor further executes:
before the sending the uplink packet from the packet queue to an optical splitter within the sending period corresponding to the access Ethernet device, activating a light source of a second optical module of the access Ethernet device and a switch indicative of sending in a second Ethernet MAC chip of the access Ethernet device; and
after the sending the uplink packet from the packet queue to an optical splitter within a sending period corresponding to the access Ethernet device, if there are no uplink packets in the packet queue or the sending period of the access Ethernet device ends, deactivating the switch indicative of sending in the second Ethernet MAC chip and the light source of the second optical module.

Based on the same technical concept, an embodiment of the present application further provides a computer-readable storage medium storing a computer program executable by a processor, where, when the program runs on the processor, the processor executes the steps of the data transmission method described above.

Those skilled in the art should understand that the embodiments of the present application may be provided as a method, system, or computer program product. Therefore, the present application may take the form of an entirely hardware embodiment, an entirely software embodiment, or an embodiment combining software and hardware aspects. Moreover, the present application may take the form of a computer program product implemented on one or more computer-usable storage media (including but not limited to disk storage, CD-ROM, optical storage, and the like) containing computer-usable program code.

The present application is described with reference to flowcharts and/or block diagrams of methods, devices (systems), and computer program products according to the present application. It should be understood that each process and/or block in the flowcharts and/or block diagrams, and combinations of processes and/or blocks in the flowcharts and/or block diagrams, may be implemented by computer program instructions. These computer program instructions may be provided to a processor of a general-purpose computer, special-purpose computer, embedded processor, or other programmable data processing device to produce a machine, such that the instructions executed by the processor of the computer or other programmable data processing device produce a device for implementing the functions specified in one or more processes in the flowcharts and/or one or more blocks in the block diagrams.

These computer program instructions may also be stored in a computer-readable memory capable of directing a computer or other programmable data processing device to operate in a specific manner, such that the instructions stored in the computer-readable memory produce a manufactured product including an instruction device that implements the functions specified in one or more processes in the flowcharts and/or one or more blocks in the block diagrams.

These computer program instructions may also be loaded onto a computer or other programmable data processing device, causing a series of operational steps to be performed on the computer or other programmable device to produce a computer-implemented process, such that the instructions executed on the computer or other programmable device provide steps for implementing the functions specified in one or more processes in the flowcharts and/or one or more blocks in the block diagrams.

Although the embodiments of the present application have been described, those skilled in the art, once they understand the basic inventive concept, may make additional changes and modifications to these embodiments. Therefore, the appended claims are intended to be interpreted as including the embodiments and all changes and modifications that fall within the scope of the present application.

Obviously, those skilled in the art may make various changes and modifications to the present application without departing from the spirit and scope of the present application. Thus, if these modifications and variations of the present application fall within the scope of the claims of the present application and their equivalent technologies, the present application is also intended to include these changes and variations.

What is claimed is:

1. A core Ethernet device, comprising a first Ethernet medium access control MAC chip and a first optical module connected to the first Ethernet MAC chip, wherein:
the first optical module is configured to receive an uplink packet sent by an optical splitter; the uplink packet is sent by a first access Ethernet device to the optical splitter within a first sending period, and the first sending period does not overlap with one or more second sending periods corresponding to one or more second access Ethernet devices connected to the optical splitter;
the first Ethernet MAC chip is configured to transmit a downlink packet to the first optical module; and
the first optical module is further configured to send the downlink packet to the optical splitter, so that the optical splitter sends the downlink packet to the first access Ethernet device and the one or more second access Ethernet devices.

2. The core Ethernet device according to claim 1, wherein the uplink packet and the downlink packet are packets in standard Ethernet frame format.

3. The core Ethernet device according to claim 1, wherein the first Ethernet MAC chip is further configured to:
determine historical transmission traffic of the first access Ethernet device;
based on the historical transmission traffic of the first access Ethernet device, determine a sending start time point and a sending duration for the first access Ethernet device; and
transmit a first downlink packet carrying an address of the first access Ethernet device, the sending start time point, and the sending duration to the first optical module.

4. The core Ethernet device according to claim 1, wherein the first Ethernet MAC chip is further configured to:
at preset intervals, transmit a second downlink packet carrying an address of the first access Ethernet device and a first sending time to the first optical module, so that the first access Ethernet device, upon receiving the second downlink packet, sends a target uplink packet carrying a first receiving time and a second sending time to the optical splitter; wherein the first sending time is a sending time of the second downlink packet, the first receiving time is a time when the first access Ethernet device receives the second downlink packet, and the second sending time is a time when the first access Ethernet device sends the target uplink packet;
based on a second receiving time, the first sending time, the first receiving time, and the second sending time, determine a target adjustment time for the first access Ethernet device; wherein the second receiving time is a time when the core Ethernet device receives the target uplink packet; and
transmit a third downlink packet carrying the address of the first access Ethernet device and the target adjustment time to the first optical module, so that the first access Ethernet device, upon receiving the third downlink packet, adjusts a time of the first access Ethernet device from a current time to the target adjustment time.

5. The core Ethernet device according to claim 4, wherein the first Ethernet MAC chip is configured to, based on the second receiving time, the first sending time, the first receiving time, and the second sending time, determine the target adjustment time for the first access Ethernet device, comprising:
subtracting the first sending time from the second receiving time to determine a response interval;
subtracting the first receiving time from the second sending time to determine a processing duration of the first access Ethernet device;
subtracting the processing duration from the response interval to obtain an uplink and downlink round-trip time, wherein half of the round-trip time is a single transmission duration;
adding the single transmission duration to the first sending time to obtain a theoretical receiving time;
comparing the first receiving time with the theoretical receiving time to obtain a time error; and
determining a sum of the current time, the time error, and the single transmission duration as the target adjustment time.

6. An access Ethernet device, comprising a second Ethernet medium access control MAC chip and a second optical module connected to the second Ethernet MAC chip, wherein:
the second Ethernet MAC chip is configured to place an uplink packet into a packet queue; and within a first sending period corresponding to the access Ethernet device, sequentially retrieve uplink packets from the packet queue and transmit the uplink packets to the second optical module;
the second optical module is configured to send the uplink packets to an optical splitter, so that the optical splitter sends the uplink packets to a core Ethernet device; and
the second optical module is further configured to determine whether a destination address of a downlink packet sent by the optical splitter is an address corresponding to the access Ethernet device; and if so, receive the downlink packet; wherein the downlink packet is sent by the optical splitter to the access Ethernet device and one or more second access Ethernet devices connected to the optical splitter after receiving the downlink packet sent from the core Ethernet device; wherein
the first sending period does not overlap with one or more second sending periods corresponding to the one or more second access Ethernet switching devices.

7. The access Ethernet device according to claim 6, wherein the uplink packet and the downlink packet are packets in standard Ethernet frame format.

8. The access Ethernet device according to claim 6, wherein the second Ethernet MAC chip is specifically configured to:
when a current time point is within the first sending period of the access Ethernet device, sequentially retrieve uplink packets from the packet queue according to an order in which the uplink packets are stored in the packet queue.

9. The access Ethernet device according to claim 6, wherein, before sequentially retrieving uplink packets from the packet queue, the second Ethernet MAC chip is further configured to:
activate a light source of the second optical module and a switch, indicative of sending, in the second Ethernet MAC chip; and
after the second optical module sends the uplink packet to the optical splitter, the second Ethernet MAC chip is further configured to:
when there are no uplink packets in the packet queue or the first sending period of the access Ethernet device ends, deactivate the switch, indicative of sending, in the second Ethernet MAC chip and the light source of the second optical module.

10. The access Ethernet device according to claim 9, wherein the switch indicative of sending is a switch provided on a transmission circuit; wherein the transmission circuit comprises a transmission circuit of a MAC layer and a transmission circuit of a physical layer of the access Ethernet device.

11. A data transmission method, applied to the core Ethernet device of claim 1, the method comprising:
receiving an uplink packet sent by an optical splitter; wherein the uplink packet is sent by a first access Ethernet device to the optical splitter within a first sending period, and the first sending period does not overlap with one or more second sending periods corresponding to one or more second access Ethernet devices connected to the optical splitter; and
sending a downlink packet to the optical splitter, so that the optical splitter sends the downlink packet to the first access Ethernet device and the one or more second access Ethernet devices.

12. The method according to claim 11, wherein the method further comprises:
determining historical transmission traffic of the first access Ethernet device;
based on the historical transmission traffic of the first access Ethernet device, determining a sending start time point and a sending duration for the first access Ethernet device; and
sending a first downlink packet carrying an address of the first access Ethernet device, the sending start time point, and the sending duration to the optical splitter.

13. The method according to claim 11, wherein the method further comprises:
at preset intervals, sending a second downlink packet carrying an address of the first access Ethernet device and a first sending time to the optical splitter, so that the first access Ethernet device, upon receiving the second downlink packet, sends a target uplink packet carrying a first receiving time and a second sending time to the optical splitter; wherein the first sending time is a sending time of the second downlink packet, the first receiving time is a time when the first access Ethernet device receives the second downlink packet, and the second sending time is a time when the first access Ethernet device sends the target uplink packet;
based on a second receiving time, the first sending time, the first receiving time, and the second sending time, determining a target adjustment time for the first access Ethernet device; wherein the second receiving time is a time when the core Ethernet device receives the target uplink packet; and
sending a third downlink packet carrying the address of the first access Ethernet device and the target adjustment time to the optical splitter, so that the first access Ethernet device, upon receiving the third downlink packet, adjusts a time of the first access Ethernet device from a current time to the corresponding target adjustment time.

14. The method according to claim 13, wherein the based on a second receiving time, the first sending time, the first receiving time, and the second sending time, determining a target adjustment time for the first access Ethernet device specifically comprises:
subtracting the first sending time from the second receiving time to determine a response interval;
subtracting the first receiving time from the second sending time to determine a processing duration of the first access Ethernet device;
subtracting the processing duration from the response interval to obtain an uplink and downlink round-trip time, wherein half of the round-trip time is a single transmission duration;
adding the single transmission duration to the first sending time to obtain a theoretical receiving time;
comparing the first receiving time with the theoretical receiving time to obtain a time error; and
determining a sum of the current time, the time error, and the single transmission duration as the target adjustment time.

15. A data transmission method, applied to the access Ethernet device of claim 6, the method comprising:
placing an uplink packet into a packet queue in the access Ethernet device and sending the uplink packet from the packet queue to an optical splitter within a first sending period corresponding to the access Ethernet device, so that the optical splitter sends the uplink packets to a core Ethernet device; and
determining whether a destination address of a downlink packet sent by the optical splitter is an address corresponding to the access Ethernet device; and if so, receiving the downlink packet; wherein the downlink packet is sent by the optical splitter to the access Ethernet device and one or more second access Ethernet devices connected to the optical splitter after receiving the downlink packet from the core Ethernet device; wherein
the first sending period does not overlap with one or more second sending periods corresponding to the one or more second access Ethernet switching devices connected to the optical splitter.

16. The method according to claim 15, wherein the sending the uplink packet from the packet queue to an optical splitter within a first sending period corresponding to the access Ethernet device comprises:
when a current time point is within the first sending period of the access Ethernet device, sequentially retrieving uplink packets from the packet queue according to an order in which the uplink packets are stored in the packet queue and sending the retrieved uplink packets to the optical splitter.

17. The method according to claim 15, wherein, before the sending the uplink packet from the packet queue to an optical splitter within a first sending period corresponding to the access Ethernet device, the method further comprises:
activating a light source of a second optical module of the access Ethernet device and a switch indicative of sending in a second Ethernet MAC chip of the access Ethernet device; and
after the sending the uplink packet from the packet queue to an optical splitter within a first sending period corresponding to the access Ethernet device, the method further comprises:
when there are no uplink packets in the packet queue or the first sending period of the access Ethernet device ends, deactivating the switch indicative of sending in the second Ethernet MAC chip and the light source of the second optical module.

18. A non-transitory computer-readable storage medium storing a computer program executable by a computer, wherein when the program runs on the computer, the computer executes the method according to claim 11.

19. A non-transitory computer-readable storage medium storing a computer program executable by a computer, wherein when the program runs on the computer, the computer executes the method according to claim 15.
